(19) United States
(12) Patent Application Publication
(10) Pub. No.: US 2006/0214918 A1
(43) Pub. Date: Sep. 28, 2006

(54) Touch sensitive display

(76) Inventors: Galileo June Adeva Destura, Eindhoven (NL); Rogier Hendrikus Magdalena Cortie, Eindhoven (NL); Jozef Thomas Martinus Van Beek, Eindhoven (NL); Antonius Lucien Adrianus Kemmeren, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/567,399

(22) PCT Filed: Aug. 3, 2004
(86) PCT No.: PCT/IB04/51366

§ 371 Date: Feb. 7, 2006

(30) Foreign Application Priority Data
Aug. 11, 2003 (EP) 03102492.0

(51) Int. Cl. G09G 5/00

(52) U.S. Cl. 345/173

(57) ABSTRACT

A touch sensitive display comprises pixels (18), each of the pixels (18) have a pixel electrode (22). An optical state of a pixel (18) depends on a drive voltage (VD) supplied to the pixel electrode (22). A touch sensitive elements (S1) is arranged between the pixel electrode (22) and a further electrode (40;17). The touch sensitive element (S1) has an impedance dependent on a mechanical force applied to it.

The invention relates to a touch sensitive display and a display apparatus comprising a touch sensitive display.

For example, such a touch sensitive display is an electrophoretic display such as an E-ink display which is particular suitable as an electronic book, in PDA's or mobile phones.

It is important that handheld display apparatuses are small and lightweight devices which can display a lot of information and have an intuitive user interaction possibility. It is known that a user can interact with the display apparatus by touching a transparent touch-screen device which is placed on top of the display screen. The touch screen will indicate the touch coordinates of a touch event to enable the display apparatus to perform the required action.

However, such touch-screens on top of the display apparatus are not able to detect multiple touch positions at the same instant and are expensive. Further, these touch-screens degrade the performance of the display.

EP-B-0416176 discloses a non-mechanical and a non-emissive matrix display which supplies signals to the row and column electrodes of the display to display information, and which senses with the row and column electrodes the position of an input pen which is electrically coupled to the display. This prior art matrix display does not require a separate touch screen. However, the pen should be electrically coupled to the display.

It is an object of the invention to provide a touch sensitive display which is able to detect touch inputs without requiring a separate touch screen and without requiring a pen which is electrically coupled to the display.

A first aspect of the invention provides a touch sensitive display as claimed in claim 1. A second aspect of the invention provides a display apparatus comprising a touch sensitive display as claimed in claim 14. Advantageous embodiments are defined in the dependent claims.

In the touch sensitive display in accordance with the first aspect of the invention, each one of the pixels has a pixel electrode to which a drive voltage is supplied which determines the optical state of the pixel. A touch sensitive element is arranged between the pixel electrode and a further electrode. The touch sensitive element has an impedance dependent on a mechanical force applied to it.

This construction of the display enables to determine the touch position from the state of the touch sensitive element provided in the touch sensitive display. The voltage on the pixel electrode determines the voltage across the pixel and thus the optical state of the pixel. If the impedance of the touch sensitive element changes due to the mechanical force applied to it, a voltage change on the further electrode will occur. This voltage change indicates a touch event at a position of the touch sensitive element associated with the pixel which is connected via the touch sensitive element to the further electrode. Thus, the bi-stable display in accordance with an embodiment of the invention comprises the touch sensitive elements in the display which obviates the electrical connection between the pen and the display.

In an embodiment in accordance with the invention as defined in claim 2, the touch sensitive display comprises a sense circuit which is coupled to the further electrode to sense the voltage on the further electrode. The sense circuit is able to sense a change in the voltage on the further electrode caused by a change in the impedance of a touch sensitive element and thus is able to detect a touch event.

In an embodiment in accordance with the invention as defined in claim 3, a predetermined voltage level is supplied to the further electrode. In this manner a touch sensitive display is obtained which provides a writing mode. The voltage at the pixel electrode changes due to the voltage on the further electrode when the impedance of the touch sensitive element changes. The voltage change on the pixel electrode causes the optical state of the pixel to change. This change of the optical state is visible and optically indicates where the display is touched: the user is able to write on the display.

It is also possible to both change the optical state of a pixel on which a mechanical force is applied and to determine the touch position. The sensing of the voltage on the further electrode and the supplying of the predetermined voltage to the further electrode may be performed at the same time or sequentially. It is possible to perform both operations at the same time, due to the predetermined voltage impressed on the further electrode, the impedance change of the touch sensitive element will cause a current which will be integrated by the sense circuit and cause a voltage change at the output of the sense circuit.

In an embodiment in accordance with the invention as defined in claim 4, the touch sensitive display is a bi-stable display such as, for example, an electrophoretic display. The electrophoretic display is for example, an E-ink display.

Usually, a bi-stable display is driven by a drive voltage which comprises a sequence of pulses. The drive voltage is supplied to the pixel electrode of each pixel during an image update period only. As the display has a bi-stable character, after the image update period, during a hold period, the image will be kept without requiring any drive voltages. Drive voltages are supplied again when the image has to be updated again.

Such a bi-stable display, wherein the image has to be updated or refreshed at a relatively low rate, and thus the optical state of the pixels is kept without requiring drive voltages for a relatively long time, has a low power consumption. However, if such a display has to detect input touch events for detecting the touch position, and/or for indicating on the display where the touch events occurred (the writing), the display should be driven with a high refresh rate. But, this would have the drawback that the power consumption of the display would increase. EP-B-0416176 discloses in one embodiment, that the touch sense function is performed for a selected row before the display data is supplied. In another embodiment, the touch sense function is performed by scanning all the rows before the display data is supplied to the selected row. Always, the touch sense function occurs at least once in a frame to enable a fast reaction on the movements of the pen, this is disclosed to be essential as the movements of the pen should be displayed on the display to enable to see the characters written by the pen on the display. This prior art matrix display does not require a separate touch screen, however, this way of sensing consumes a relatively high power.

The touch sensitive display in accordance with the embodiment of the invention as defined in claim 4 is actively driven only during an image update period to refresh the image. No active drive pulses are required during the hold periods in-between the image update periods.

The sense circuit in accordance with an embodiment in accordance with the invention is able to detect a voltage change on the further electrode caused by an impedance change of the touch sensitive element without requiring any drive pulses. Thus, the sense circuit is able to detect the state of the touch sensitive element by only using the voltage on the pixel and a supply voltage. The position of the touch event can be detected during the hold period, a high refresh rate is not required, and thus the power consumption of the display is still low.

The writing requires a predetermined voltage level on the further electrode. It suffices to supply the predetermined voltage level to the further electrode to obtain a change of the optical state of the pixels when the impedance of the pressure sensitive element decreases due to a touch event. Although this predetermined voltage has to be supplied during at least part of the hold period, the power consumption is still low as no rapidly changing voltages have to be supplied, and it is not required to address the pixels in the usual manner line by line.

Thus, both the sensing and the writing can be performed during the hold period. Consequently, the bi-stable display can be driven at a low refresh rate and thus dissipates a low power.

In an embodiment in accordance with the invention as defined in claim 5, preferably, the display is a matrix display such that the pixels are uniformly spread over the area of a display screen of the display such that the resolution of the display is evenly spread and it is possible to use the display to write or draw on it with a good quality.

In an embodiment in accordance with the invention as defined in claim 6, first, during an image update period, an image update has to be performed to bring the pixels into the first optical state. Then, a hold periods follows during which the display need not be addressed anymore, it suffices that a particular voltage level is supplied to the further electrodes. The particular voltage level is selected to have substantially no influence on the optical state of a pixel if no touch force is applied on the associated touch sensitive element because the electronic switch is maintained in the insulating state and to change the optical state of the pixel if a touch force is applied on the associated touch sensitive element. For example, in the first optical state, all the pixels become white and the voltage supplied to the further electrodes is selected such that the pixels becomes grey or black if the impedance of the touch sensitive element decreases due to a touch event.

If the sensing or writing is required in a sub-area of the display only, only the pixels within this sub-area are brought into the first optical state, and only the further electrodes associated with this sub-area need to supply the particular voltage level.

In an embodiment in accordance with the invention as defined in claim 7, the select electrodes are used as the further electrodes. Thus, the touch sensitive elements are connected between the pixels electrodes and the select electrodes, and no separate extra further electrodes are required. During image update periods, the select driver supplies the select voltages to the select electrodes and the data voltages to the data electrodes. During the sensing mode during which the touch-sensing is possible, the voltages on the select electrodes are sensed to determine the position of the touch event. During the writing mode, the particular voltage is supplied to the relevant select electrodes.

In an embodiment in accordance with the invention as defined in claim 8, during the writing mode, first the relevant pixels are brought to a well defined optical state and than the particular voltage level is supplied to the select electrodes. If the writing is only required in a sub-area of the display, only the relevant select electrodes have to supply the voltage level.

In an embodiment in accordance with the invention as defined in claim 9, when a mechanical force is supplied at the position of a particular pixel, the first mentioned touch sensitive switch supplies the pixel voltage to the associated select electrode, and the further touch sensitive switch connects the voltage on the select electrode associated with the particular pixel to the data electrode associated with the particular pixel. Thus, the two-dimensional position of the touch event can be detected at the select electrodes and the data electrodes. If the further touch sensitive switch is not present, it is only possible to detect the vertical position of a touch event.

In an embodiment in accordance with the invention as defined in claim 10, when a mechanical force is supplied at the position of a particular pixel, the first mentioned touch sensitive switch supplies the pixel voltage to the associated select electrode, and the further touch sensitive switch connects the voltage on the associated pixel electrode to the associated data electrode. Thus, the two-dimensional position of the touch event can be detected at the select electrodes and the data electrodes.

In an embodiment in accordance with the invention as defined in claim 13, the touch sensitive element and/or the further touch sensitive element are a switch. The switch has a very high impedance when open, such that the voltage on the pixel electrode is minimally influenced when the switch is open. The switch has a very low impedance when closed, such that the pixel electrode is optimally coupled to the further electrode, the select electrode or the data electrode.

These and other aspects of the invention are apparent from and will be elucidated with reference to the embodiments described hereinafter.

In the drawings:

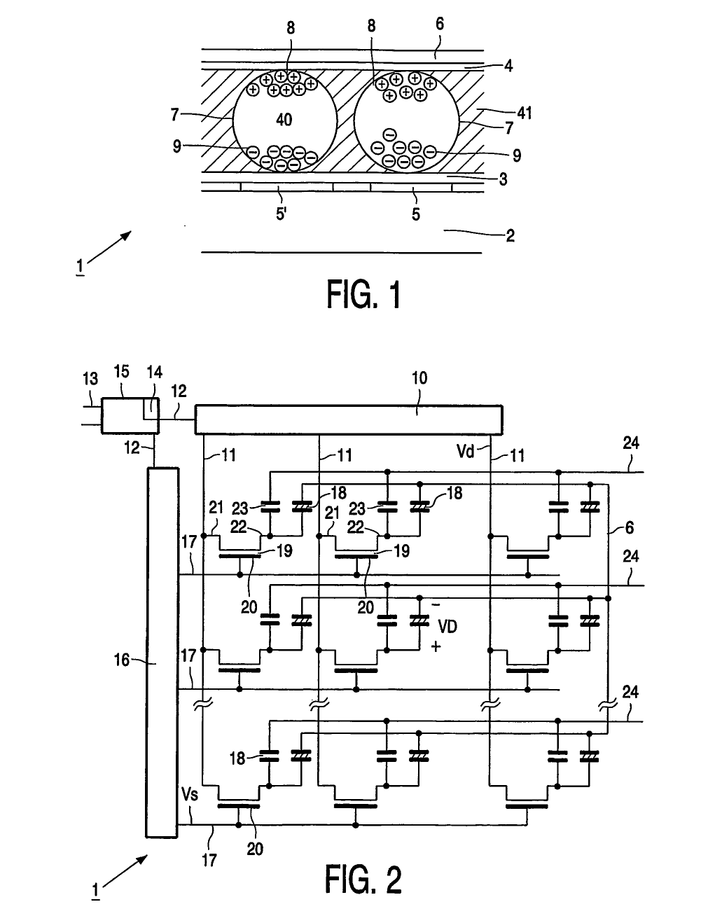

FIG. 1 shows diagrammatically a cross-section of a portion of an electrophoretic display,

FIG. 2 shows diagrammatically a picture display apparatus with an equivalent circuit diagram of a portion of the electrophoretic display,

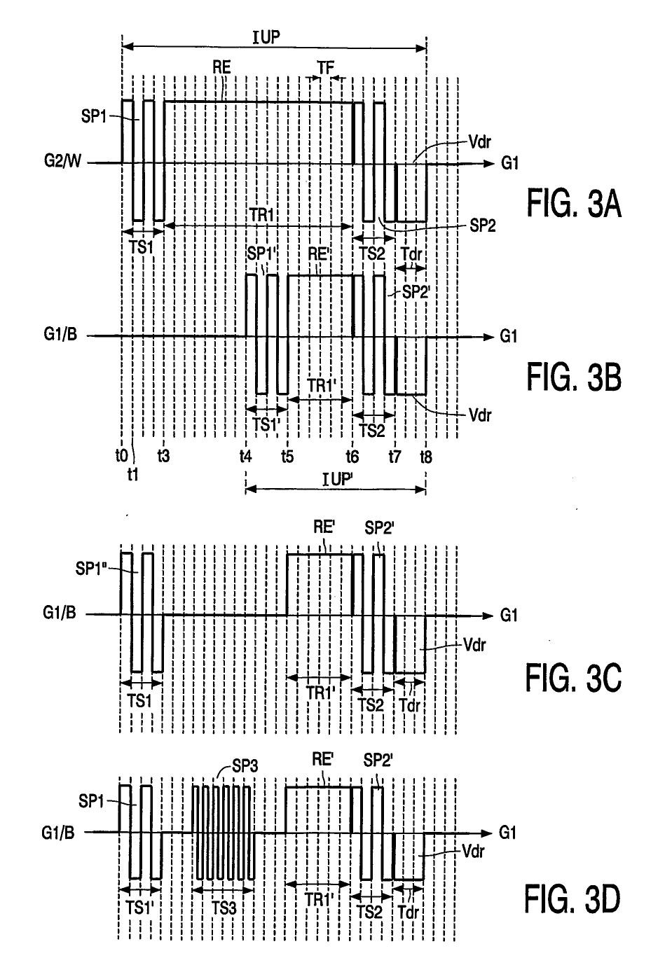

FIG. 3 shows voltages across a pixel in different situations wherein over-reset and various sets of shaking pulses are used,

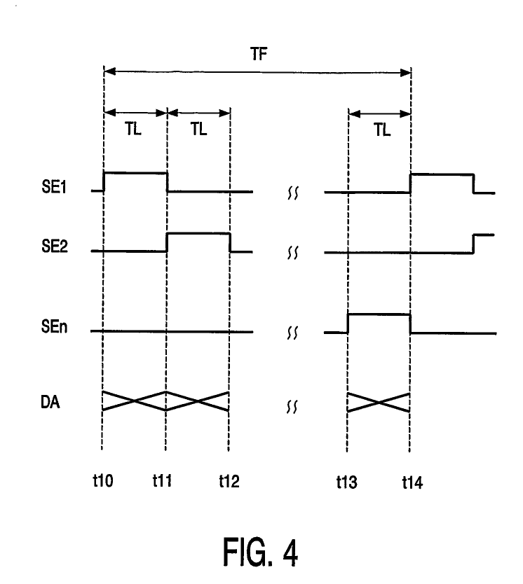

FIG. 4 shows signals occurring during a frame period,

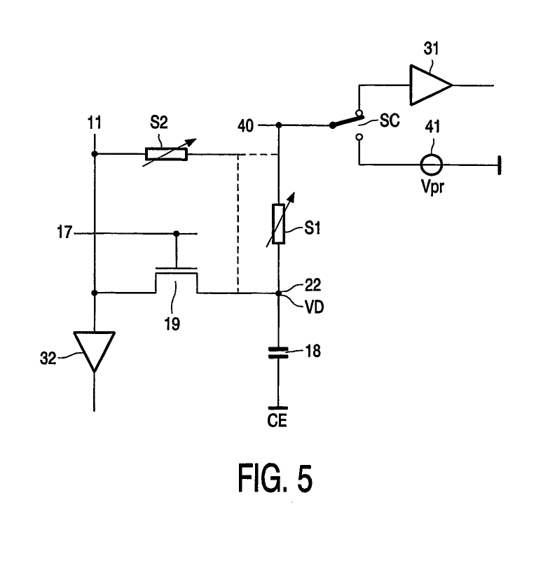

FIG. 5 shows a circuit diagram of a portion of the display in accordance with an embodiment of the invention, and

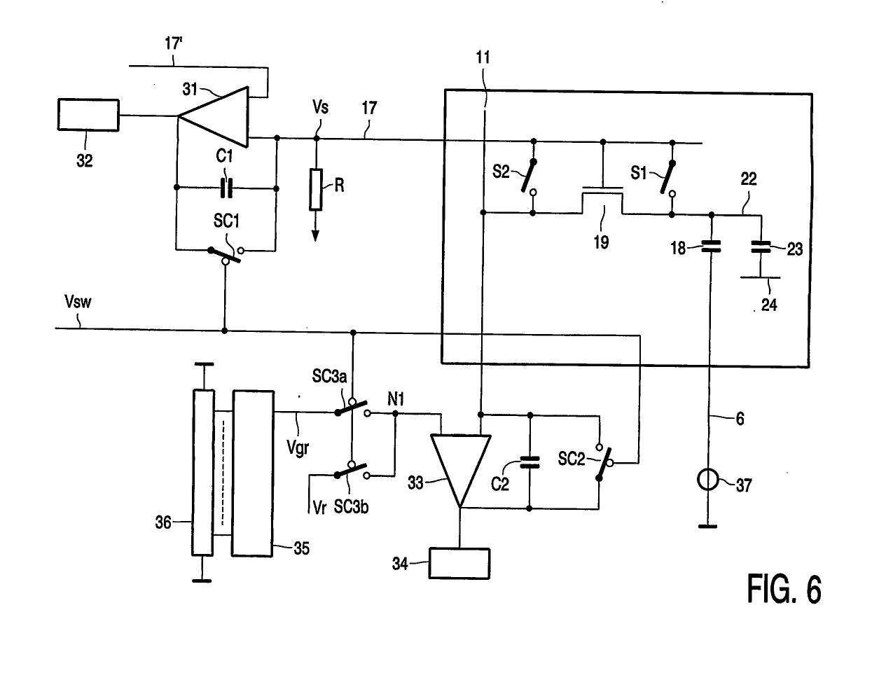

FIG. 6 shows a circuit diagram of a portion of the display in accordance with another embodiment of the invention.

FIGS. 1 to 4 elucidate embodiments of driving an electrophoretic display to form a framework for explaining embodiments in accordance with the present invention with respect to FIGS. 5 and 6.

FIG. 1 shows diagrammatically a cross-section of a portion of an electrophoretic display, which for example, to improve clarity, has the size of a few display elements only. The electrophoretic display comprises a base substrate 2, an electrophoretic film with an electronic ink which is present between two transparent substrates 3 and 4 which, for example, are of polyethylene. One of the substrates 3 is provided with transparent pixel electrodes 5, 5′ and the other substrate 4 with a transparent counter electrode 6. The counter electrode 6 may also be segmented. The electronic ink comprises multiple microcapsules 7 of about 10 to 50 microns. Each microcapsule 7 comprises positively charged white particles 8 and negatively charged black particles 9 suspended in a fluid 40. The dashed material 41 is a polymer binder. The layer 3 is not necessary, or could be a glue layer. When the pixel voltage VD across the pixel 18 (see FIG. 2) is supplied as a positive drive voltage Vdr (see, for example, FIG. 3) to the pixel electrodes 5, 5′ with respect to the counter electrode 6, an electric field is generated which moves the white particles 8 to the side of the microcapsule 7 directed to the counter electrode 6 and the display element will appear white to a viewer. Simultaneously, the black particles 9 move to the opposite side of the microcapsule 7 where they are hidden from the viewer. By applying a negative drive voltage Vdr between the pixel electrodes 5, 5′ and the counter electrode 6, the black particles 9 move to the side of the microcapsule 7 directed to the counter electrode 6, and the display element will appear dark to a viewer (not shown). When the electric field is removed, the particles 8,9 remain in the acquired state and the display exhibits a bi-stable character and consumes substantially no power. Electrophoretic media are known per se from e.g. U.S. Pat. No. 5,961,804, U.S. Pat. No. 6,1120,839 and U.S. Pat. No. 6,130,774 and may be obtained from E-ink Corporation.

FIG. 2 shows diagrammatically a picture display apparatus with an equivalent circuit diagram of a portion of the electrophoretic display. The picture display device 1 comprises an electrophoretic film laminated on the base substrate 2 provided with active switching elements 19, a row driver 16 and a column driver 10. Preferably, the counter electrode 6 is provided on the film comprising the encapsulated electrophoretic ink, but, the counter electrode 6 could be alternatively provided on a base substrate if a display operates based on using in-plane electric fields. Usually, the active switching elements 19 are thin-film transistors TFT. The display device 1 comprises a matrix of display elements associated with intersections of row or select electrodes 17 and column or data electrodes 11. The row driver 16 consecutively selects the row electrodes 17, while the column driver 10 provides data signals in parallel to the column electrodes 11 to the pixels associated with the selected row electrode 17. Preferably, a processor 15 firstly processes incoming data 13 into the data signals to be supplied by the column electrodes 11.

The drive lines 12 carry signals which control the mutual synchronisation between the column driver 10 and the row driver 16.

The row driver 16 supplies an appropriate select pulse Vs to the gates of the TFT's 19 which are connected to the particular row electrode 17 to obtain a low impedance main current path of the associated TFT's 19. The gates of the TFT's 19 which are connected to the other row electrodes 17 receive a voltage Vs such that their main current paths have a high impedance. The low impedance between the source electrodes 21 and the drain electrodes of the TFT's allows the data voltages Vd present at the column electrodes 11 to be supplied to the drain electrodes which are connected to the pixel electrodes 22 of the pixels 18. In this manner, a data signal Vd present at the column electrode 11 is transferred to the pixel electrode 22 of the pixel or display element 18 coupled to the drain electrode of the TFT if the TFT is selected by an appropriate level on its gate. In the embodiment shown, the display device of FIG. 1 also comprises an additional capacitor 23 at the location of each display element 18. This additional capacitor 23 is connected between the pixel electrode 22 and one or more storage capacitor lines 24. Instead of TFTs, other switching elements can be used, such as diodes, MIMs, etc.

FIG. 3 shows voltages across a pixel in different situations wherein over-reset is used. FIGS. 3A to 3D show different methods to drive an electropheretic display. By way of example, FIGS. 3 are based on an electrophoretic display with black and white particles and four optical states: black B, dark grey G1, light grey G2 and white W. FIG. 3A shows an image update period IUP for a transition from light grey G2 or white W to dark grey G1. FIG. 3B shows an image update period IUP′ for a transition from dark grey G1 or black B to dark grey G1. The vertical dotted lines represent the frame periods TF (which usually last 20 milliseconds), the line periods TL occurring within the frame periods TF are not shown in FIGS. 3. The line periods TL are illustrated in FIG. 4.

In both FIG. 3A and FIG. 3B, the pixel voltage VD across a pixel 18 comprises successively first shaking pulses SP1, SP1′ , a reset pulse RE, RE‘, second shaking pulses SP2, SP2‘ and a drive pulse Vdr. The drive pulses Vdr occur during the same drive period Tdr which lasts from instant t7 to instant t8. The second shaking pulses SP2, SP2′ immediately precede the driving pulses Vdr and thus occur during a same second shaking period TS2. The reset pulse RE, RE‘ immediately precede the second shaking pulses SP2. SP2‘. However, due to the different duration TR1, TR1‘ of the reset pulses RE, RE‘, respectively, the starting instants t3 and t5 of the reset pulses RE, RE‘ are different. The first shaking pulses SP1, SP1‘ which immediately precede the reset pulses RE, RE‘, respectively, thus occur during different first shaking periods in time TS1, TS1‘, respectively.

The second shaking pulses SP2, SP2‘ occur for every pixel 18 during a same second shaking period TS2. This enables to select the duration of this second shaking period TS2 much shorter as shown in FIGS. 3A and 3B. For clarity, each one of levels of the second shaking pulses SP2, SP2‘ is present during the standard frame period TF. In fact, during the second shaking period TS2, the same voltage levels can be supplied to all the pixels 18. Thus, instead of selecting the pixels 18 line by line, it is now possible to select all the pixels 18 at once, and only a single line select period TL (see FIG. 4) suffices per level. Thus, in FIGS. 3A and 3B, the second shaking period TS2 only needs to last four line periods TL instead of four standard frame periods TF. However, it is still possible to only select groups of lines (not comprising all the lines) of pixels at the same time to lower the capacitive currents and thus the dissipation.

Alternatively, it is also possible to change the timing of the drive signals such that the first shaking pulses SP1 and SP1‘ are aligned in time, the second shaking pulses SP2 are then no longer aligned in time (not shown). Now the first shaking period TS1 can be much shorter. It is even possible to both align both the first shaking pulses SP1, SP1′ and both the second shaking pulses SP2, SP2‘ as is shown in FIG. 3A for the same optical transition as shown in FIG. 3B.

The driving pulses Vdr are shown to have a constant duration, however, the drive pulses Vdr may have a variable duration.

If the drive method shown in FIGS. 3A and 3B is applied to the electrophoretic display, outside the second shaking period TS2, the pixels 18 have to be selected line by line by activating the switches 19 line by line. The voltages VD across the pixels 18 of the selected line are supplied via the column electrodes 11 in accordance with the optical state the pixel 18 should have. For example, for a pixel 18 in a selected row of which pixel the optical state has to change from white W to dark grey G1, a positive voltage has to be supplied at the associated column electrode 11 during the frame period TF starting at instant t0. For a pixel 18 in the selected row of which pixel the optical state has to change from black B to dark grey G1, a zero voltage has to be supplied at the associated column electrode during the frame period TF lasting from instants t0 to t1.

FIG. 3C shows a waveform which is based on the waveform shown in FIG. 3B. This waveform of FIG. 3C causes the same optical transition. The difference is that the first shaking pulses SP1‘ of FIG. 3B are now shifted in time to coincide with the shaking pulses SP1 of FIG. 3A. The shifted shaking pulses SP1‘ are indicated by SP1″. Thus, now, independent on the duration of the reset pulse RE, also all the shaking pulses SP1, SP1″ occur during the same shaking period TS1. This has the advantage that independent of the optical transition, both the same shaking pulses SP1, SP1″ and SP2, SP2‘ can be supplied to all pixels 18 simultaneously. Thus both during the first shaking period TS1 and the second shaking period TS2 it is not required to select the pixels 18 line by line. Whilst in FIG. 3C the shaking pulses SP1″ and SP2‘ have a predetermined high or low level during a complete frame period, it is possible to use shaking pulses SP1″ and SP2‘ lasting one or more line periods TL (see FIG. 7). In this manner, the image update time may be maximally shortened. Further, due to the selection of all lines at the same time and providing a same voltage to all columns, during the shaking periods TS1 and TS2, the capacitances between neighboring pixels and electrodes will have no effect. This will minimize stray capacitive currents and thus dissipation. Even further, the common shaking pulses SP1, SP1″ and SP2, SP2‘ enable implementing shaking by using structured counter electrodes 6.

A disadvantage of this approach is that a small dwell time is introduced (between the first shaking pulse period TS1 and the reset period TR1‘). Dependent on the electrophoretic display used, this dwell time should not become longer than, for example, 0.5 seconds.

FIG. 3D shows a waveform which is based on the waveform shown in FIG. 3C. To this waveform third shaking pulses SP3 are added which occur during a third shaking period TS3. The third shaking period TS3 occurs between the first shaking pulses SP1 and the reset pulse RE‘, if this reset pulse RE‘ does not have it maximum length. The third shaking pulses SP3 may have a lower energy content than the first shaking pulses SP1 to minimize the visibility of the shaking. It is also possible that the third shaking pulses SP3 are a continuation of the first shaking pulses SP1. Preferably, the third shaking pulses SP3 fill up the complete period in time available between the first shaking period TS1‘ and the reset period TR1‘ to minimize the image retention and to increase the grey scale accuracy. With respect to the drive method shown in FIG. 3C, the image retention is further reduced and the dwell time is massively reduced.

Alternatively, it is possible that the reset pulse RE‘ occurs immediately after the first shaking pulses SP1 and the third shaking pulses occur between the reset pulse RE′ and the second shaking pulses SP2‘.

The possible drive methods of an electrophoretic display as shown in FIGS. 3 are based on an over-reset. The image retention can be further improved by using reset pulses RE, RE‘ which have a length which is proportional to the distance the particles 8, 9 have to move between the pixel electrode 5, 5‘ and the counter electrode 6.

Electrophoretic displays may be driven in many other manners, for example, the reset pulses may be absent.

FIG. 4 shows signals occurring during a frame period. Usually, each frame period TF indicated in FIGS. 3 comprises a number of line periods TL which is equal to a number of rows of the electrophoretic matrix display. In FIG. 4, one of the successive frame periods TF is shown in more detail. This frame period TF starts at the instant t10 and lasts until instant t14. The frame period TF comprises n line periods TL. The first line period TL lasts from instant t10 to t11, the second line period TL lasts from instant t11 to t12, and the last line period TL lasts from instant t13 to t14.

Usually, during the frame period TF, the rows are selected one by one by supplying appropriate select pulses SE1 to SEn to the rows. A row may be selected by supplying a pulse with a predetermined non-zero level, the other rows receive a zero voltage and thus are not selected. The data DA is supplied in parallel to all the pixels 18 of the selected row. The level of the data signal DA for a particular pixel 18 depends on the optical state transition of this particular pixel 18.

Thus, if different data signals DA may have to be supplied to different pixels of a column, the frame periods TF shown in FIGS. 3 comprise the n line or select periods TL. However, if the first and second shaking pulses SP1 and SP2 occur during the same shaking periods TS1 and TS2, respectively, for all the pixels 18 simultaneously, it is possible to select all the lines of pixels 18 simultaneously and it is not required to select the pixels 18 line by line. Thus, during the frame periods TF shown in FIGS. 3 wherein common shaking pulses are used, it is possible to select all the pixels 18 in a single line period TL by providing the appropriate select pulse to all the rows of the display. Consequently, these frame periods may have a significantly shorter duration (one line period TL, or a number of line periods less than n, instead of n) than the frame periods wherein the pixels 18 associated with the columns may receive different data signals.

By way of example, the addressing of the display is elucidated in more detail with respect to FIG. 3C. At the instant t0 a first frame period TF of an image update period IUP starts. The image update period IUP ends at the instant t8.

The first shaking pulses SP1″ are supplied to all the pixels 18 during the first shaking period TS1 which lasts from instant t0 to instant t3. During this first shaking period TS1, during each frame period TF, all (or a group of) the lines of pixels 18 are selected simultaneously during at least one line period TL and the same data signals are supplied to all columns of the display. The level of the data signal is shown in FIG. 3C. For example, during the first frame period TF lasting from instant t0 to t1, a high level is supplied to all the pixels. During the next frame period TF starting at instant t1, a low level is supplied to all the pixels. A same reasoning is valid for the common second shaking period TS2.

The duration of the reset pulse RE, RE‘ may be different for different pixels 18 because the optical transition of different pixels 18 depends on the image displayed during a previous image update period IUP and the image which should be displayed at the end of the present image update period IUP. For example, a pixel 18 of which the optical state has to change from white W to dark grey G1, a high level data signal DA has to be supplied during the frame period TF which starts at instant t3, while for a pixel 18 of which the optical state has to change from black B to dark grey G1, a zero level data signal DA is required during this frame period. The first non-zero data signal DA to be supplied to this last mentioned pixel 18 occurs in the frame period TF which starts at the instant t4. In the frames TF wherein different data signals DA may have to be supplied to different pixels 18, the pixels 18 have to be selected row by row.

Thus, although all the frame periods TF in FIGS. 3 are indicated by equidistant vertical dotted lines, the actual duration of the frame periods may be different. In frame periods TF in which different data signals DA have to be supplied to the pixels 18, usually the pixels 18 have to be selected row by row and thus n line select periods TL are present. In frame periods TF in which the same data signals DA have to be supplied to all the pixels 18, the frame period TF may be as short as a single line select period TL. However, it is possible to select all the lines simultaneously during more than a single line select period TL. It is also possible to select successively sub-groups of the lines, each sub-group is selected during one or several line select periods.

FIG. 5 shows a circuit diagram of a portion of the display in accordance with an embodiment of the invention. FIG. 5 shows a single cell of the display. The cell comprises a pixel 18 with a pixel electrode 22. The other electrode of the pixel 18 is usually called the common electrode CE and usually is connected to a same voltage for all the pixels. By way of example, the common electrode CE is shown to be connected to ground. An electronic switch 19 has a main current path arranged between the pixel electrode 22 and the data or column electrode 11. A control input of the electronic switch is coupled to the select or row electrode 17. The touch sensitive element S1 is arranged between the pixel electrode 22 and the electrode 40. A switch SC connects the buffer 31 or the voltage source 41 to the electrode 40.

If the touch position has to be determined, the switch SC connects the buffer 31 to the electrode 40. When the display is not touched at the position of the touch sensitive element S1, the impedance of the touch sensitive element S1 is very high and the voltage across the pixel 18 is not supplied to the electrode 40 via the touch sensitive element S1. However, when a force is applied to the touch sensitive element S1, its impedance decreases and the pixel 18 will be connected to the electrode 40. The voltage on the electrode will change which is detected by the buffer 31. The buffer 31 is preferably an integrating buffer. The output of the buffer 31 indicates that a touch event has been detected at a pixel 18 associated with the electrode 40.

A further touch sensitive switch S2 may be present between the column electrode 11 and either the pixel electrode 22 or the electrode 40, as indicated by the dotted lines. A buffer 32 is coupled to the column electrode 11. During a touch sense period, the buffer 32 senses the voltage on the column electrode 11. If a force is applied to the touch sensitive switch S2, its impedance becomes low and the voltage on the pixel electrode 22 is fed to the column electrode 11 directly, or via the low impedance touch sensitive switch S1. It is assumed the touch sensitive switches S1 and S2 are closely spaced such that both will get a low impedance when a touch event at or near at the associated pixel 18 occurs. Now, in a matrix display in which each pixel 18 is associated with a particular row electrode 17 and a particular column electrode 11, it is possible to determine the position of a touch event with pixel accuracy.

If the touch event should cause a change of the optical state of the pixel(s) 18 at the touch position, preferably, first all the pixels 18 are brought into a well defined optical state. Thereafter, the switch SC connects the voltage source 41 to the electrode 40. Now, the voltage Vpr is present on the electrode 40. If no force is applied to the touch sensitive element S1, its impedance is high and the voltage Vpr on the electrode 40 does not influence the optical state of the pixel 18. If, due to a touch event, a force is applied to the touch sensitive element S1, its impedance decreases, the voltage Vpr on the electrode 40 influences the voltage at the pixel electrode 22 and the optical state of the pixel 18 changes.

In this manner, it is possible to “write” on the display screen. If the user presses a moving finger, stylus or any other object along the display screen, the pressure will change the impedance of the corresponding touch sensitive elements S1. The optical state of the associated pixels 18 will change and thus, a virtual ink follows the trail of the object. This gives the user the sense that he or she is writing on the display screen.

The change of the optical state of the pixel 18 depends on the voltage difference between the voltage VD on the pixel electrode 22 before the impedance of the touch sensitive element S1 decreased and the voltage Vpr on the electrode 40, and on the impedance change of the touch sensitive element S1. Preferably, a large change in the optical state is reached such that a clear indication of the touch event is given. A large change of the optical state of the pixel 18 is obtained if the well defined optical state to which the pixels 18 are first brought is one of two limit optical states (for example, white, if the display comprises white and black particles). While the voltage source Vpr supplies a voltage which changes the optical state of the pixels 18 into the other limit state (in the example referred to: black). To be able to obtain the maximum voltage change at the pixel electrode 22, preferably, the impedance of the touch sensitive element S1 is very high if no force is applied, and very low if a force is applied. The high impedance should be high enough to prevent the pixel 18 to change the optical state if no force is applied. The low impedance should be low enough to change the optical state of the pixel 18 as much as possible. Preferably, the touch sensitive element is a resistive Micro Electro Mechanical (MEM) switch which can be integrated into the active substrate of the display.

FIG. 6 shows a circuit diagram of a portion of the display in accordance with another embodiment of the invention. Only one cell of a matrix display is shown, the other cells have a same construction. A pixel 18 is arranged between the pixel electrode 22 and the counter electrode 6. A voltage source 37 supplies a common voltage to the counter electrode 6. A storage capacitor 23 is arranged between the pixel electrode 22 and one or more storage capacitor lines 24. The electronic switch 19 (which usually are TFT's) has a main current path arranged between the pixel electrode 22 and the data electrode 11. The control input of the electronic switch 19 is connected to the select electrode 17. A touch sensitive element S1 is arranged between the pixel electrode 22 and the select electrode 17. A touch sensitive element S2 is arranged between the data electrode 11 and the select electrode 17. Both the touch sensitive element S1 and S2 are arranged near the pixel 18.

A buffer 31 has an input connected to the select electrode 17, an input connected to a switch line 17‘, and an output connected to an analog to digital converter (further referred to as ADC) 32. A resistor R is arranged between the select electrode 17 and ground. A parallel arrangement of a capacitor C1 and a switch SC1 is arranged between the select electrode 17 and the output of the buffer 31.

A buffer 33 has an input connected to the data electrode 11, an input connected to a node N1, and an output connected to the ADC 34. A parallel arrangement of a capacitor C2 and a switch SC2 is arranged between the data electrode 11 and the output of the buffer 33. A resistor ladder 36 and a 1 out of 64 multiplexer 35 generates one out of 64 possible voltage levels Vgr at an output of the multiplexer 35. A switch SC3a is arranged to supply the voltage levels Vgr to the node N1. A switch SC3b is arranged between the node N1 and the a reference voltage Vr. The switches SC1, SC2, SC3a and SC3b are controlled by a switch voltage Vsw. The switches SC1, SC2, SC3a and SC3b are shown in the position required for touch sensing.

First, the normal operation mode without touch sensing is elucidated. The switch SC1 is closed and the buffer 31 supplies the usual select voltages on the switch line 17 to the select electrodes 17. Also the switches SC2 and SC3a are closed and the buffer 33 supplies the voltage levels Vgr to the data electrodes 11. If the matrix display is an electrophoretic display, during an image update period, the required pulses or pulse sequences are supplied to the select electrodes 17 to select the lines (rows) of pixels 18 one by one while the data signals are supplied in parallel to the data electrodes 11. No pulses are supplied during the hold period.

Now, the operation with the touch position sensing is elucidated. The switch SC1 is open, such that the buffer 31 operates as an integrator which integrates the current on the select electrode 17. The switches SC2 and SC3a are open and switch SC3b is closed such that the buffer 33 operates as an integrator which integrates the current on the data electrode 11. If a mechanical force is applied at the position of a pixel 18, both the switches S1 and S2 will close and the voltage across the pixel 18 and the storage capacitor 23 will cause a current towards the buffers 31 and 33. Thus, the touch position can be detected by sampling the output voltages of the select electrodes 17 and the data electrodes 11. The sampling is performed during the hold period of the display, and the speed of sampling can be adapted to the needs. Thus, the sampling is possible at a low power consumption.

Now, the operation of the writing mode is elucidated. First in the normal operation mode, all the pixels 18 are addressed to obtain the same optical state. If the display has a restricted area in which can be written, it is only required to address the pixels 18 in this area to get the predetermined optical state. Then, the voltage on the switch line 17‘ is changed to get a value such that the electronic switches 19 do not conduct, and such that when this voltage is supplied to the pixel electrode 22, the optical state of the pixel 18 changes. The voltage Vs on the select electrode 17 which is substantially equal to the voltage on the switch line 17‘ is supplied to the pixel electrode 22 if the switch S I closes due to a touch event. The predetermined voltage level can be put on the select lines 17 during the hold period of the display.

It is possible, during the hold period, to sequentially perform a touch position sensing and a write detection.

It should be noted that the above-mentioned embodiments illustrate rather than limit the invention, and that those skilled in the art will be able to design many alternative embodiments without departing from the scope of the appended claims.

For example, although the operation, for the ease of explanation, is elucidated with respect to a single pixel 18, it is easily conceivable how to operate a matrix display wherein lines of pixels 18 are selected. With every pixel 18 in an area where a touch input should be detected both the switches S1 and S2 should be present, while a buffer has to be available for every select electrode 17 and every data electrode 11 associated with these pixels 18. With every pixel where writing should be possible, the switch S1 should be present, while it should be possible to supply the predetermined voltage to all the select electrodes 17 associated with these pixels 18.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A touch sensitive display comprising
pixels (18), each of the pixels (18) having a pixel electrode (22) and an optical state depending on a drive voltage (VD) supplied to the pixel electrode (22), and
a touch sensitive element (Si) arranged between the pixel electrode (22) and a further electrode (40;17), the touch sensitive element (S1) having an impedance dependent on a mechanical force applied to it.

2. A touch sensitive display as claimed in claim 1, further comprising a sense circuit (31) for sensing a voltage on the further electrode (40).

3. A touch sensitive display as claimed in claim 1, wherein a predetermined voltage level (Vpr) is supplied to the further electrode (40).

4. A touch sensitive display as claimed in claim, wherein the touch sensitive display is a bi-stable display.

5. A touch sensitive display as claimed in claim 1, wherein the touch sensitive display is an active matrix display (1) comprising
select electrodes (17) and data electrodes (11), the pixels (18) being associated with intersections of the select electrodes (17) and the data electrodes (11),
a select driver (16) for supplying select voltages (Vs) to the select electrodes (17),
a data driver (10) for supplying data voltages (Vd) to the data electrodes (11),
electronic switches (19), each being associated with a respective one of the pixels (18), and
a controller (15) for controlling the select driver (16) to select the pixels (18) associated with at least one of the select electrodes (17) by activating the electronic switches (19) being associated with the at least one of the select electrodes (17), and for controlling the data driver (10) to supply the data voltages (Vd) to the pixel electrodes (22) of the pixels (18) associated with at least one of the select electrodes (17).

6. A touch sensitive display as claimed in claim 5, wherein the touch sensitive display further comprises a voltage source (Vpr) for supplying, within at least a sub-area of the display, a predetermined voltage to the further electrode (40), and wherein with each of the pixels (18) of the sub-area a touch sensitive element (Si) is associated, the controller (15) being arranged for controlling the select driver (16) and the data driver (10) to first bring all the pixels (18) of the sub-area into a predetermined first optical state, and wherein a level of the predetermined voltage (Vpr) is selected to obtain the electronic switches (19) being non-conductive and to obtain a voltage on the pixel electrode (22) causing a change of the optical state of a particular one of the pixels (18) of the sub-area when the mechanical force is applied to the touch sensitive element (S1) associated with this particular pixel (18).

7. A touch sensitive display as claimed in claim 6, wherein the further electrode (40) is divided into a plurality of further electrodes being the select electrodes (17) and the touch sensitive elements (S1) are arranged between the pixel electrodes (22) and the select electrodes (17).

8. A touch sensitive display as claimed in claim 7, wherein the controller (15) is arranged for controlling the select driver (16) and the data driver (10) to first bring, in at least a sub-area of the display, all the pixels (18) into the predetermined first optical state, and then the select driver (16) to supply the predetermined voltage level (Vpr) to all the select electrodes (17).

9. A bi-stable display as claimed in claim 7, wherein the touch sensitive display further comprises further touch sensitive switches (S2) being associated with the pixels (18) and being arranged between the select electrodes (17) and the data electrodes (11) of the pixels (18).

10. A bi-stable display as claimed in claim 7, wherein the touch sensitive display further comprises further touch sensitive switches (S2) being associated with the pixels (18) and being arranged between the pixel electrodes (22) and the data electrodes (11) of the pixels (18).

11. A touch sensitive display as claimed in claim 1, wherein the touch sensitive element (Si) has an impedance which decreases when a touch force is applied.

12. A touch sensitive display as claimed in claim 1,
wherein the further touch sensitive element (S2) has an impedance which decreases when a touch force is applied.

13. A touch sensitive display as claimed in claim 11 wherein the touch sensitive element (Si) and/or the further touch sensitive element (S2) is a switch.

14. A display apparatus comprising a touch sensitive display as claimed in claim 1.
